(19) United States
(12) Patent Application Publication
(10) Pub. No.: US 2011/0174942 A1
(43) Pub. Date: Jul. 21, 2011

(54) Three-in-one (3-in-1) trivet

(76) Inventor: Susan M. Moberg, Lancaster, PA (US)

(21) Appl. No.: 12/589,722

(22) Filed: Jan. 21, 2010

(51) Int. Cl. A47G 29/00; F16M 13/00; F16M 13/02

(52) U.S. Cl. 248/206.5; 248/346.01; 248/346.11

(57) ABSTRACT

A coaster tray (trivet) comprising a base tray with removable coasters functioning in three ways: Firstly intact, as a large trivet/tray for protecting surfaces from hot dishes; secondly with tiles removed, as transportable coasters or small trivets for glasses, hot mugs, etc; and thirdly, individual tiles for use as emergency refrigerator magnets. The coasters (tiles) are readily at hand because they are held in the steel-lined tray by magnets, and need only a rocking pressure to release. The coasters/tiles/magnets can be utilized individually while the rest of the set remains in the tray. This simple device also allows the owner to swap out and/or replace coasters (tiles) at will; problems with breakage and boredom are remedied.

### BACKGROUND AND SUMMARY OF INVENTION

I have been painting/glazing bisque-ware for sale at a local pottery shop (The Pottery Works, Lancaster, Pa.) since January of 2005, and have completed numerous pieces including several large trivets comprising six (6) 4″ tiles glued and grouted into a frame or handled butler's tray. In February of 2008, bored with the static nature of the large six tile trivet, I decided to shake things up by thinking outside the conventional box—why not let the tiles free and interchangeable

My “THREE-IN-ONE” (3-in-1) TRIVET is the playful result: Instead of gluing the glazed, decorated tiles in place, I adhered soft magnets to their backs, and placed them in the (shop-provided) frames/trays to which I had glued a thin sheet of steel to the inside surface.

This design allows the device to be used:
1) Intact:—as a center table protector/ hot dish holder (trivet)/or serving tray
   1a)—as a storage device for set of (6) coasters
   1b)—as a decorative wall hanging
2) With tiles removed—as individual coasters
3) And quirkily—as single-tile emergency refrigerator magnets.
   Additional benefits of this removable tile system include ease of replacement (for breakage) and optional change of decor. Seasonally decorated (and/or party) sets of six magnetized tiles can be manufactured for separate purchase.

### DEFINITION OF TERMS

Trivet: an insulating device for holding hot dishes above counters and or tabletops thereby protecting their surfaces from damage (usually stationery)
Butler's Tray: a serving tray with handles often as a removable top on a legged base
Coaster: any of a number of shaped (or insulated) devices used under glassware to protect furniture from heat or condensation, made from wide variety of materials
Refrigerator magnet: a magnetized decorative object used to adfix papers, photos, lists, etc to refrigerator doors (business giveaways often used for advertising)
   The prototype debuted in February of 2008. Six four by four inch tiles were painted and glazed (a painting of a fossilized pterodactyl), fired, soft magnets stuck to their backs, and then arranged in a tray/frame to which I had glued a steel insert. The “THREE-IN-ONE” (3-in-1) TRIVET was born.

### REFERENCES CITED

U.S. patent Documents

5356008 Oct. 18, 1994 Chung 206/449 206/560 206/564 248/346.1

3013688 December 1961 Luning

4858872 Aug. 22, 1989 Witt 248/346.1

3175726 March 1965 Levy

D274489 April 1975 Svensson

248346110 Apr. 19, 2006 Calvanese

U.S. 2002/0063078A1

U.S. 2004/0238551

U.S. 20040064621

### SPECIFICATION AND DRAWINGS

### THREE-IN-ONE (3-In-1) TRIVET

Susan Moberg, inventor

3 Claims

8 Drawings (8 pages)

7 photographs as (examples) previously submitted

### BRIEF DESCRIPTION OF DRAWINGS

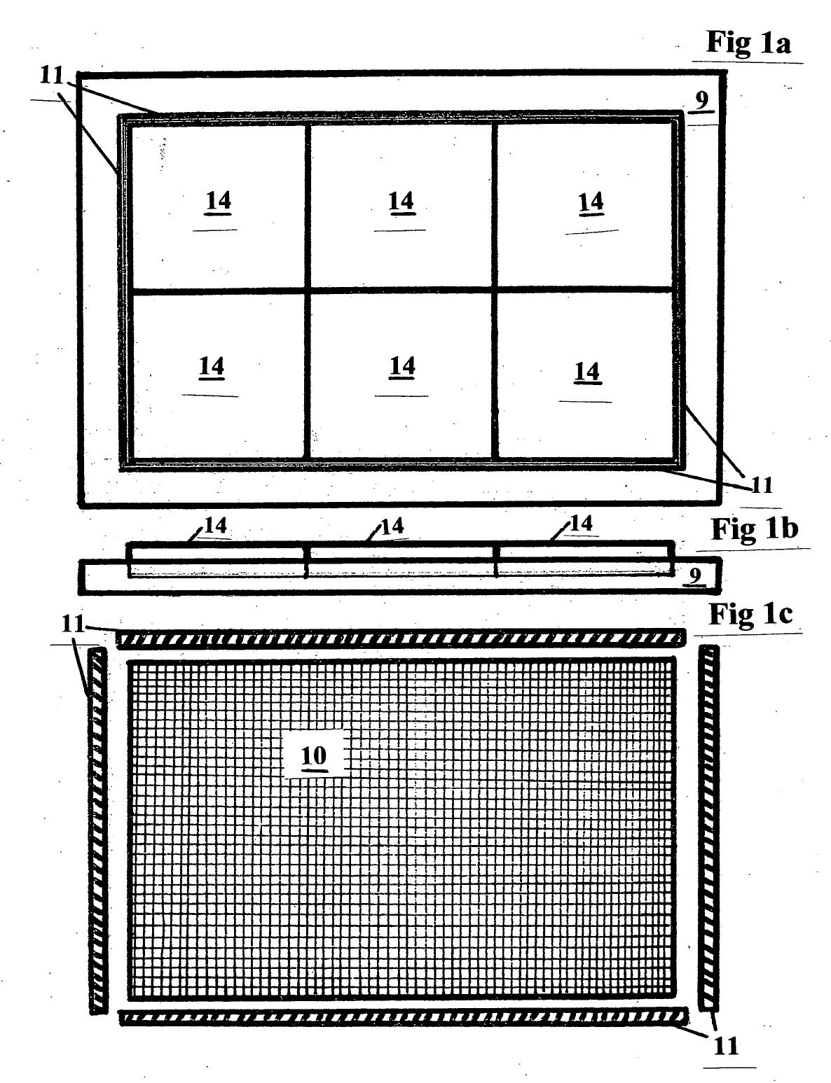

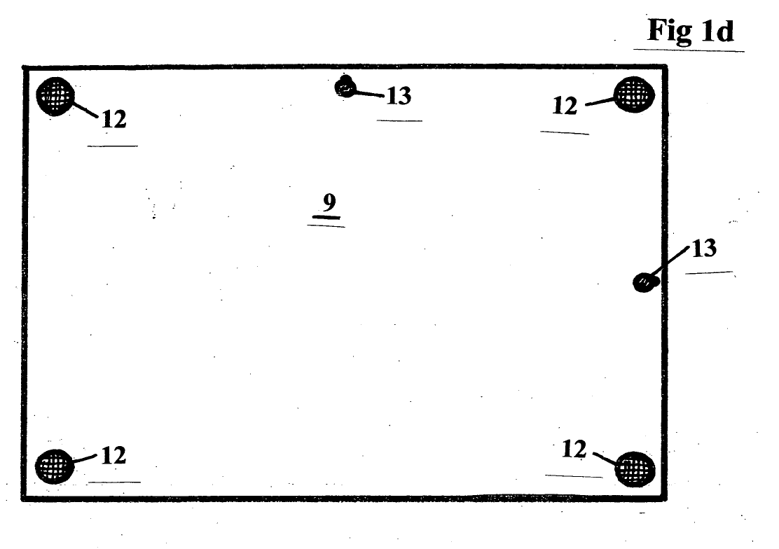

FIG. 1 is the top view of trivet intact

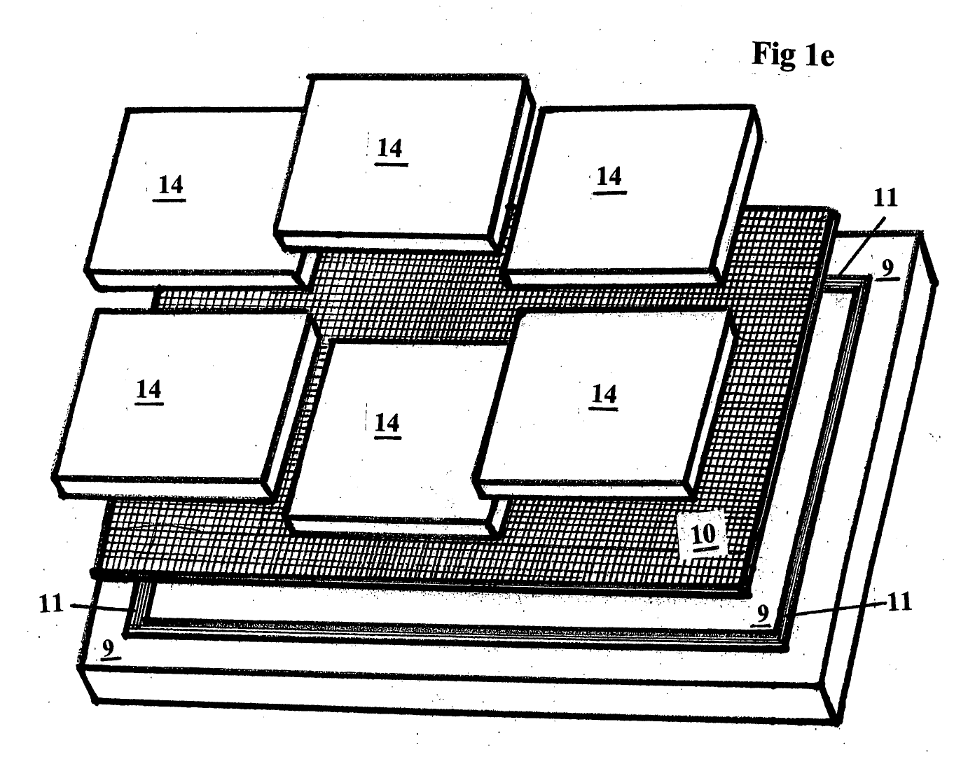

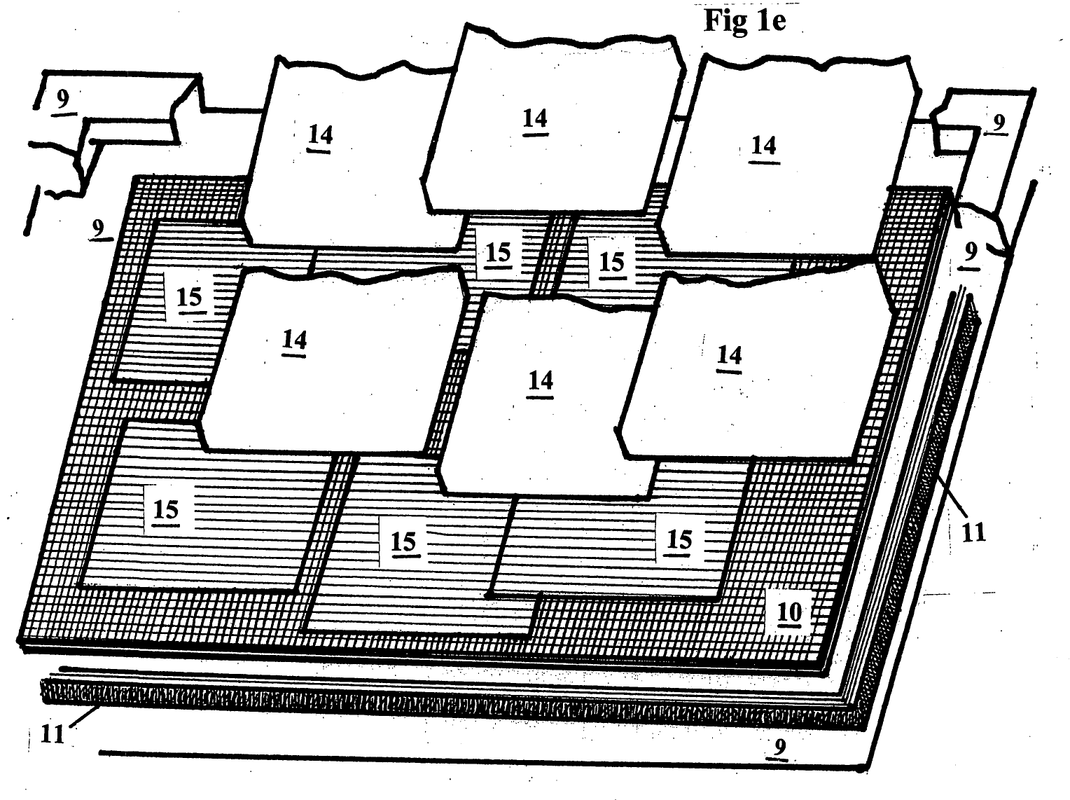

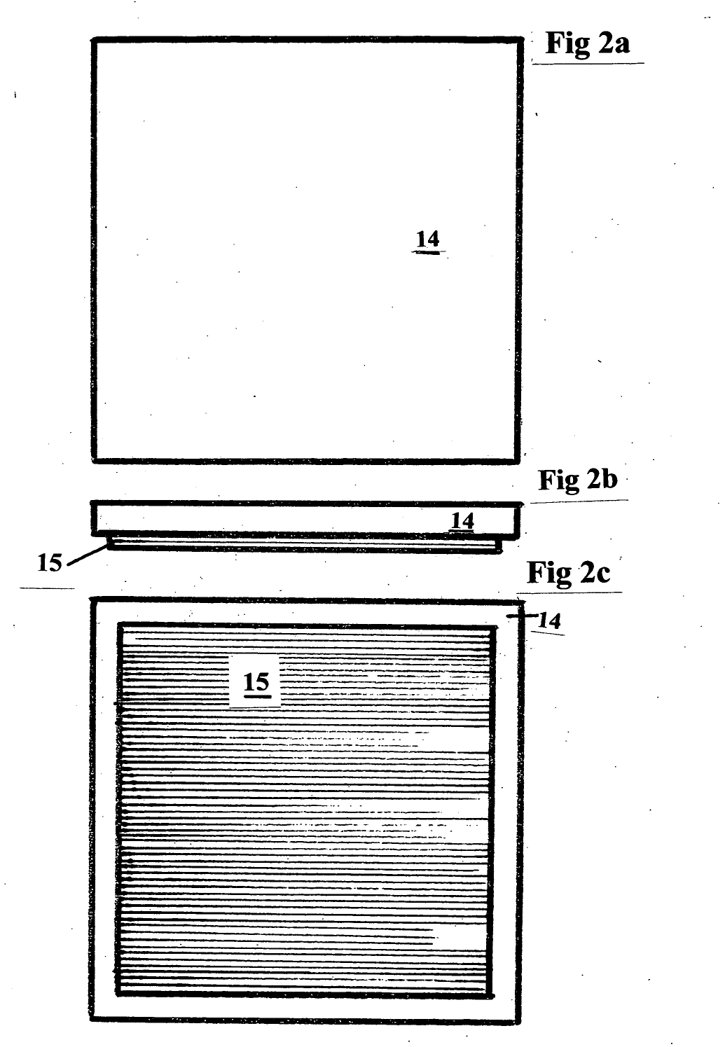

FIG. 2 is a cross section of FIG. 1 (the trivet intact)

FIG. 3 shows steel insert and foam bumpers which line interior

FIG. 4 shows top view of one of the tiles (coasters)

FIG. 5 is a cross section of tile showing attached magnet

FIG. 6 is a bottom view of tile with magnet

FIG. 7 shows exploded view of assembled (intact) trivet

FIG. 8 shows the bottom of tray

#9 tray
#10 steel insert
#11 colored foam bumpers
# 12 foot pads
# 13 holes for hanging hardware
# 14 tile
# 15 soft magnet

### Structure

The trivet shown in FIG. 1-8 consists of a tray 9 in which six tiles 14 (coasters) nest. The tray 9 has been modified with a steel sheet 10 glued to the inner surface, and the tiles 14 “improved” with the addition of soft magnets 15 to their backs. This allows the device (trivet) to be used in two conditions: assembled as a large trivet FIG. 1 and with tiles 14 removed as individual coasters/small trivets or as refrigerator magnets FIG. 7.

This is a simple modification of an old static design. The ease of disassembly and conversely assembly makes the trivet an attractively functional addition to the kitchen. A rocking pressure applied to the tiles loosens the magnetic attraction and they can be tipped out of the tray as needed. It is not necessary to remove more tiles than are necessary for immediate use—i.e. the remaining tiles can be left in place.

1. A tray or trivet comprised of tiles—ungrouted and held in place by means of individually adhered magnets which assembled, will function as a large trivet for protecting surfaces from oven-hot dishes. In addition, the tray acts as a storage device for the tiles, which can be hung out of the way on a wall.

2. Removing the tiles from the tray with a simple rocking motion, allows the individual components to be used as portable coasters or small trivets for cold or hot items. The entire tray of tiles need not be disassembled to access one for use; the magnets hold the remainder in place.

3. Additionally, the individual magnetized tiles may be removed giving them a third use i.e. as emergency refrigerator magnets.
An important aside: the ease with which the tiles can be replaced enables the user to change them out either individually for breakage or in sets. Owners may wish to own extra “seasonally decorated” sets of tiles to decorate for parties or just add a little variety.
